(19) United States
(12) Patent Application Publication
(10) Pub. No.: US 2024/0260551 A1
(43) Pub. Date: Aug. 8, 2024

(54) Over Flow Box Filter

(71) Applicant: Conner J. King, SR., Loveland, CO (US)

(72) Inventor: Conner J. King, SR., Loveland, CO (US)

(21) Appl. No.: 18/165,834

(22) Filed: Feb. 7, 2023

(51) Int. Cl. A01K 63/04; C02F 1/00; C02F 1/28

(52) U.S. Cl. CPC A01K 63/045; A01K 63/047; C02F 1/001; C02F 1/283; C02F 2103/20; C02F 2301/046

(57) ABSTRACT

An overflow box filter is formed of plastic. It includes connections for external filter supply and drain tie-in, window for viewing inside, sponge filter, carbon filter, manual or electronic priming system, top surface skimming slots, over the wall pipe chase, water top off or feeding port, manual or electronic feeding system, powerhead/(s), system control interface, probes and sensors. The unit hangs on any tank rim, external panel or side wall and may be sized to match any system load requirement. Use includes manual or automatic priming, the transfer of water from one tank to another, internal supply and return flow, and the ability to provide food manually or automatically from a submerged food release port.

### FIELD OF INVENTION

The present invention relates generally to a box filter which hangs over the tank wall of any aquarium and is used to transfer unfiltered water from inside the main tank/habitat chamber containment area to an external filter system which resides outside the aquarium. After filtering, the newly filtered and processed water is then pumped back into the over flow box filter where it is then returned inside the tank chamber once again. This circulating process continues uninterrupted.

### BACKGROUND ART

There are various types of over flow box filters on the market today, most are complicated in nature and limited in functionality. Many, if not all of these filters provide little in the way of added features which can address the extended needs of most modern aquarists.

Some limitations of these filters include the sparse offerings provided after initial installation, set up and priming.

They offer little or no ability for the aquarist to add more water when topping off their existing main tank/habitat chamber containment area's internal water level after main tank/habitat chamber containment area evaporation has taken place.

Other disadvantages include a missing method for the combined use of a sponge pre-filter which adds mechanical filtration, and a carbon media filter which adds chemical filtration upon initial startup of the filtration system.

There is also traditionally the lack of any provided top surface skim slots for contaminant and algae bloom removal.

Few if any, provide powerheads for bi-directional main tank/habitat chamber containment area return water inflow control.

Additionally, there exists the need for some type of feeding apparatus which would provide the inhabitants of the main tank/habitat chamber containment area with submerged food release, this being a feature which would help to eliminate the top feeding habits of most fish and address a condition in fish which is known as Physostomous, or air-bladder disease.

The lack of sufficient technology to incorporate the use of a built in controller which would include a thermostat and set of diodes and probes, a combination which would provide the aquarist with the pertinent real time information needed in regard to the current status of the water quality that is present within the main tank/habitat chamber containment area itself.

Finally, there is the overall disadvantage that most over flow box filters have which is that they are solely independent in design and construction and they do not participate or belong to any distinct family or complete system of like products which covers the full spectrum of internal water filtration, purification and processing, this alone rendering them obsolete and most likely incompatible when the aquarist is constructing a new, or expanding an existing filtration system in their overall support of an aquatic environment.

### BRIEF SUMMARY OF THE INVENTION

An aspect of the present invention is to provide an over flow box filter which is incredibly versatile and easy to install, set up, and use.

An aspect of the present invention is to provide a dual drain configuration with an optional single drain conversion pipe adapter which will connect two drains to one single drain pipe.

Another aspect of the present invention is to provide a translucent or clear window for viewing inside the filter.

Another aspect of the present invention is to provide a method for the combined use of a sponge pre-filter which adds mechanical filtration to the system, and a carbon media pre-filter which adds chemical filtration to the system.

Another aspect of the present invention is to provide the use of an external priming system which is available in both a manual prime or an optional electronic prime configuration.

Another aspect of the present invention is to provide a translucent finger push priming bulb with bubble check which indicates and removes any air build up within the external electronic priming system.

Another aspect of the present invention is to provide a combination external manual top-off water fill, additive, and food port which can be used for manually adding chemicals, additives or food to the system, or water to top-off the main tank/habitat chamber containment area after evaporation has taken place.

Another aspect of the present invention is to provide an independent slide soak feeder tank wall clip.

Another aspect of the present invention is to provide a manual soak feeder assembly or optional electronic soak feeder attachment for the application of submerged food release prior to feeding, a mechanism which eliminates the top feeding habits of fish and addresses the condition in fish which is known as Physostomous, or air-bladder disease.

Another aspect of the present invention is to provide a suitable mounting port for the addition of an assortment of bi-directional and adjustable flow manifolds as well as other aftermarket powerhead assemblies which would assist with main tank/habitat chamber containment area circulation and water return inflow.

Another aspect of the present invention is to provide a suitable mounting port for the addition of an assortment of bi-directional and adjustable flow manifolds as well as other aftermarket powerhead assemblies which would assist with main tank/habitat chamber containment area circulation and water return inflow.

Another aspect of the present invention is to provide a manual soak feeder assembly or optional electronic soak feeder attachment for the application of submerged food release prior to feeding, a mechanism which eliminates the top feeding habits of fish and addresses the condition in fish which is known as Physostomous, or air-bladder disease.

Another aspect of the present invention is to provide a multitude of top surface skimming slots which continuously remove the main tank/habitat chamber containment area's upper column of water and any contaminants which float up to the surface or reside there.

Another aspect of the present invention is to provide a controller with a built-in thermometer and a complete set of diodes and probes which grant the aquarist with a digital display of pertinent real time information regarding the current status of the existing water quality that is contained within their systems main tank/habitat chamber containment area itself.

Another aspect of the present invention is to provide a compatible new member to an already growing family of scientifically engineered, designed and tested aquatic products which make up an entire process system for both internal and external water purification and processing.

This invention relates generally to the field of aquatics and more specifically, to the processes used in the transfer of water from an aquarium or main tank/habitat chamber containment area, sump or pond and out to an external filtration unit for processing before then returning the water back to the aquarium or main tank/habitat chamber containment area, sump or pond, once again.

Since the invention of the overflow box filter, participants in the aquatics game have strived for perfection and reliability in the techniques and equipment being used for aquatic water processing, all while enjoying the fun filled world of aquatics and the personal and family gratification which such activities provide.

There is a complete industry built in the support of the hobby of aquatics. From standard and specialty designed tanks, sumps, filtration systems, lighting and equipment, to multi-million-dollar aquariums located all over the world.

Designs and patents exist on all phases of both indoor and outdoor system designs and supporting equipment. Currently, a fully option filled over flow box filter design has no present representation in any type of modern aquatic market place, with the exception of existing units that may look similar in nature, but have no connection with an overall complete system configuration which is as versatile and expansive as the in-depth system design being presented.

### BRIEF DESCRIPTION OF THE DRAWINGS

FIG. 1 depicts an exploded isometric assembly view of all the parts contained in the manual prime configuration from the embodiment of the present invention

FIG. 2 depicts an exploded isometric assembly view of all the parts contained in the optional electronic prime conversion controller kit version from the embodiment of the present invention with FIG. 1 A1, B1, H, I and AB being replaced with optional FIG. 2 A2, B2, AC, AD, AE, AF, AG, AH, AI, AA2 and AA3.

FIG. 3 depicts an exploded isometric assembly view of all the parts contained in the embodiment of an optional FIG. 3 manual soak feeder attachment version J, K and L from the embodiment of the present invention.

FIG. 4 depicts an exploded isometric assembly view of all the parts contained in the embodiment of an optional FIG. 4 automatic soak feeder attachment version M, N, O, P, L, AA1 and Q from the embodiment of the present invention.

FIG. 5 depicts an exploded isometric assembly view of all the parts contained in the embodiment of an optional stand-alone accessory, FIG. 5 sliding soak feeder tank wall clip R, which can incorporate the optional FIG. 3 manual soak feeder attachment version J, K and L, or the optional FIG. 4 automatic soak feeder attachment version M, N, O, P, L, AA1 and Q from the embodiment of the present invention.

FIG. 6 depicts a block diagram bill of materials or BOM which consists of individual line items as each is depicted in their alphabetical order of appearance as shown in FIG. 1, FIG. 2, FIG. 3, 4 and FIG. 5 from the embodiment of the present invention.

FIG. 7 depicts a front plan view of the manual prime version without options from the embodiment of the present invention.

FIG. 8 depicts a left side plan view of the manual prime version without options of the present invention.

FIG. 9 depicts a front plan view of the optional electronic prime version from the embodiment of the present invention.

FIG. 10 depicts a left side plan view of the optional electronic prime version from the embodiment of the present invention.

FIG. 11 depicts a back plan view of the manual prime version without options from the embodiment of the present invention.

FIG. 12 depicts a right-side plan view of the manual prime version without options from the embodiment of the present invention.

FIG. 13 depicts a back plan view of the optional electronic prime version from the embodiment of the present invention.

FIG. 14 depicts a right-side plan view of the optional electronic prime version from the embodiment of the present invention.

FIG. 15 depicts a top plan view of the manual prime version without options from the embodiment of the present invention.

FIG. 16 depicts a bottom plan view of the manual prime version without options from the embodiment of the present invention.

FIG. 17 depicts a top plan view of the optional electronic prime version from the embodiment of the present invention.

FIG. 18 depicts a bottom plan view of the optional electronic prime version from the embodiment of the present invention.

FIG. 19 depicts a front plan view of FIG. 1 box bottom enclosure housing A1, of the manual prime version from the embodiment of the present invention.

FIG. 20 depicts a left side plan view of FIG. 1 box bottom enclosure housing A1 of the manual prime version from the embodiment of the present invention.

FIG. 21 depicts a right-side plan view of FIG. 1 box bottom enclosure housing A1 of the manual prime version from the embodiment of the present invention.

FIG. 22 depicts a back plan view of FIG. 1 box bottom enclosure housing A1 of the manual prime version from the embodiment of the present invention.

FIG. 23 depicts a front perspective view of FIG. 1 box bottom enclosure housing A1 of the manual prime version from the embodiment of the present invention.

FIG. 24 depicts a top plan view of FIG. 1 box bottom enclosure housing A1 of the manual prime version from the embodiment of the present invention.

FIG. 25 depicts a bottom plan view of FIG. 1 box bottom enclosure housing A1 of the manual prime version from the embodiment of the present invention.

FIG. 26 depicts a back perspective view of FIG. 1 box bottom enclosure housing A1 of the manual prime version from the embodiment of the present invention.

FIG. 27 depicts a top plan view with Section A-A, Section B-B and Section C-C of FIG. 1 box bottom enclosure housing A1 of the manual prime version from the embodiment of the present invention.

FIG. 28 depicts a front plan view of Section A-A of FIG. 1 box bottom enclosure housing A1 of the manual prime version from the embodiment of the present invention.

FIG. 29 depicts a front plan view of Section B-B of FIG. 1 box bottom enclosure housing A1 of the manual prime version from the embodiment of the present invention.

FIG. 30 depicts a back plan view of Section C-C of FIG. 1 box bottom enclosure housing A1, of the manual prime version from the embodiment of the present invention.

FIG. 31 depicts a front plan view of FIG. 2 box bottom enclosure housing A2, of the optional electronic prime version from the embodiment of the present invention.

FIG. 32 depicts a left side plan view of FIG. 2 box bottom enclosure housing A2, of the optional electronic prime version from the embodiment of the present invention.

FIG. 33 depicts a right-side plan view of FIG. 2 box bottom enclosure housing A2, of the optional electronic prime version from the embodiment of the present invention.

FIG. 34 depicts a back plan view of FIG. 2 box bottom enclosure housing A2, of the optional electronic prime version from the embodiment of the present invention.

FIG. 35 depicts a front perspective view of FIG. 2 box bottom enclosure housing A2, of the optional electronic prime version from the embodiment of the present invention.

FIG. 36 depicts a top plan view of FIG. 2 box bottom enclosure housing A2, of the optional electronic prime version from the embodiment of the present invention.

FIG. 37 depicts a bottom plan view of FIG. 2 box bottom enclosure housing A2, of the optional electronic prime version from the embodiment of the present invention.

FIG. 38 depicts a back perspective view of FIG. 2 box bottom enclosure housing A2, of the optional electronic prime version from the embodiment of the present invention.

FIG. 39 depicts a top plan view with Section D-D, Section E-E and Section F-F of FIG. 2 box bottom enclosure housing A2, of the optional electronic prime version from the embodiment of the present invention.

FIG. 40 depicts a front plan view of Section D-D of FIG. 2 box bottom enclosure housing A2, of the optional electronic prime version from the embodiment of the present invention.

FIG. 41 depicts a front plan view of Section E-E of FIG. 2 box bottom enclosure housing A2, of the optional electronic prime version from the embodiment of the present invention.

FIG. 42 depicts a back plan view of Section F-F of FIG. 2 box bottom enclosure housing A2, of the optional electronic prime version from the embodiment of the present invention.

FIG. 43 depicts a top plan view of FIG. 1 box top enclosure housing B1, with FIG. 2 box top enclosure housing B2, of the optional electronic prime version from the embodiment of the present invention being similar.

FIG. 44 depicts a bottom plan view of FIG. 1 box bottom enclosure housing A1, with FIG. 2 box bottom enclosure housing A2, of the optional electronic prime version from the embodiment of the present invention being similar.

FIG. 45 depicts a back assembly perspective view of FIG. 1 over flow box filter, with FIG. 2 over flow box filter of the optional electronic prime version from the embodiment of the present invention being similar.

FIG. 46 depicts a front perspective view of FIG. 1 box bottom enclosure housing A1, with FIG. 2 box bottom enclosure housing B1, of the optional electronic prime version from the embodiment of the present invention being similar.

FIG. 47 depicts a front assembly plan view of FIG. 1 over flow box filter, with FIG. 2 over flow box filter of the optional electronic prime version from the embodiment of the present invention similar.

FIG. 48 depicts a right-side assembly plan view of FIG. 1 over flow box filter, with FIG. 2 over flow box filter of the optional electronic prime version from the embodiment of the present invention being similar.

FIG. 49 depicts a back perspective view of FIG. 2 over flow box filter, with FIG. 1 over flow box filter of the optional electronic prime version from the embodiment of the present invention being similar.

FIG. 50 depicts a front perspective view of FIG. 2 box bottom enclosure housing A2, with FIG. 1 box bottom enclosure housing A1, of the optional electronic prime version from the embodiment of the present invention being similar.

FIG. 51 depicts a front assembly perspective view of an optional FIG. 1 single bi-directional power head manifold Y, Z1 from the embodiment of the present invention.

FIG. 52 depicts a front assembly perspective view of an optional FIG. 1 dual strait bi-directional power head manifold X, Z1, Z2 from the embodiment of the present invention.

FIG. 53 depicts a front assembly perspective view of an optional FIG. 1 dual-Y bi-directional power head manifold W, Z1, Z2 from the embodiment of the present invention.

FIG. 54 depicts a front assembly perspective view of an optional FIG. 1 quad strait bi-directional power head manifold V, Z1, Z2, Z3, Z4 from the embodiment of the present invention.

FIG. 55 depicts a front assembly perspective view of an optional FIG. 3 manual soak feeder J, K, and L from the embodiment of the present invention.

FIG. 56 depicts a front assembly perspective view of an optional FIG. 4 electronic soak feeder M, N, O, P, AA1 and Q from the embodiment of the present invention.

FIG. 57 depicts a front assembly perspective view of an optional FIG. 1 siphon, priming bulb AB from the embodiment of the present invention.

FIG. 58 depicts a front perspective view of an optional FIG. 1 sponge pre-filter F from the embodiment of the present invention.

FIG. 59 depicts a front perspective view of an optional FIG. 1 carbon media pre-filter G from the embodiment of the present invention.

FIG. 60 depicts a front assembly perspective view of an optional FIG. 2 finger push prime bulb AC from the embodiment of the present invention.

FIG. 61 depicts a front perspective view of an optional FIG. 2 batteries AA2, AA3 and FIG. 4 AA1 from the embodiment of the present invention being similar.

FIG. 62 depicts a front assembly perspective view of an optional FIG. 2 automatic prime enclosure AA2, AA3, AE, AF, AG, AH and AI from the embodiment of the present invention.

FIG. 63 depicts a back assembly perspective view of an optional FIG. 2 automatic prime enclosure AA2, AA3, AE, AF, AG, AH and AI from the embodiment of the present invention.

FIG. 64 depicts a front assembly perspective view of an optional thermostatic control interface, from the embodiment of the present invention.

FIG. 65 depicts a back assembly perspective view of FIG. 1 over flow box filter, with FIG. 2 over flow box filter of the optional electronic prime version from the embodiment of the present invention being similar, enclosure shown mounted to an external filter system.

FIG. 66 depicts a front assembly perspective view of FIG. 1 over flow box filter, with FIG. 2 over flow box filter of the optional electronic prime version from the embodiment of the present invention being similar, enclosure shown mounted to an external filter system.

FIG. 67 depicts a front assembly plan view of FIG. 1 over flow box filter, with FIG. 2 over flow box filter of the optional electronic prime version from the embodiment of the present invention being similar, enclosure shown in an optional larger size.

FIG. 68 depicts a front perspective view of an optional FIG. 5 sliding manual soak feeder body R from the embodiment of the present invention.

FIG. 69 depicts a front assembly perspective view of FIG. 1 over flow box filter, with FIG. 2 over flow box filter of the optional electronic prime version from the embodiment of the present invention being similar.

FIG. 70 depicts a front assembly perspective view of FIG. 1 over flow box filter, with FIG. 2 over flow box filter of the optional electronic prime version from the embodiment of the present invention being similar, enclosures shown in an optional larger size.

FIG. 71 depicts a front assembly perspective view of optional FIG. 2 electronic prime version over flow box filter, with FIG. 1 over flow box filter from the embodiment of the present invention being similar.

FIG. 72 depicts a front assembly perspective view of optional FIG. 2 electronic prime version over flow box filter, with FIG. 1 over flow box filter from the embodiment of the present invention being similar, enclosures shown in an optional larger size.

FIG. 73 depicts a front assembly perspective view of FIG. 1 over flow box filter, with FIG. 2 over flow box filter of the optional electronic prime version from the embodiment of the present invention being similar, enclosure shown mounted to a single connection of a dual connection external filter system.

FIG. 74 depicts a front assembly perspective view of FIG. 1 over flow box filter, with FIG. 2 over flow box filter of the optional electronic prime version from the embodiment of the present invention being similar, enclosure shown mounted to a single connection of a two-connection external filter system.

FIG. 75 depicts a front assembly perspective view of FIG. 1 over flow box filter, with FIG. 2 over flow box filter of the optional electronic prime version from the embodiment of the present invention being similar, enclosures shown mounted to two connections of a four-connection external filter system.

FIG. 76 depicts a front assembly perspective view of FIG. 1 over flow box filter, with FIG. 2 over flow box filter of the optional electronic prime version from the embodiment of the present invention being similar, enclosures shown mounted to four connections of a six-connection external filter system.

### DETAILED DESCRIPTION OF THE INVENTION

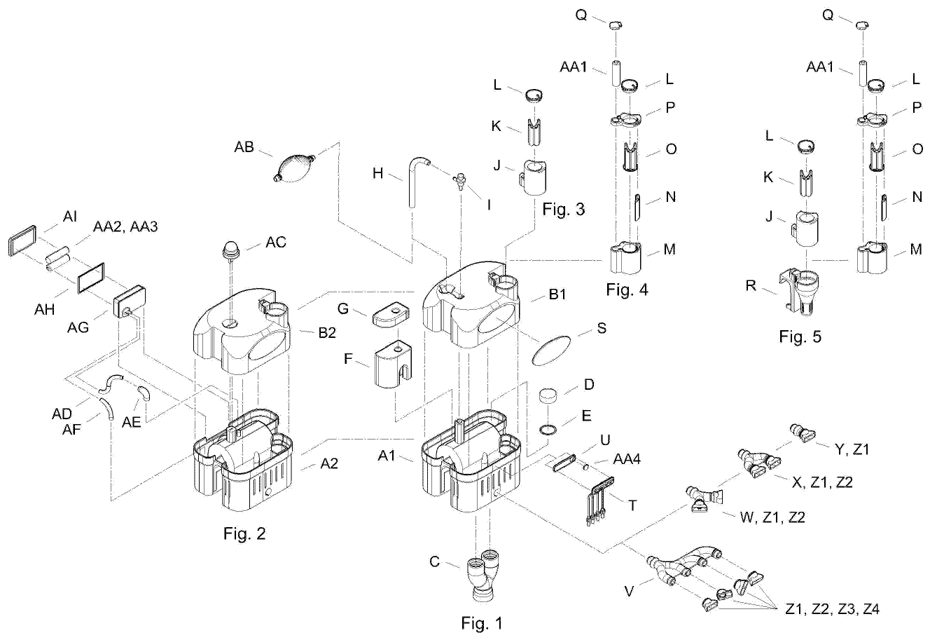

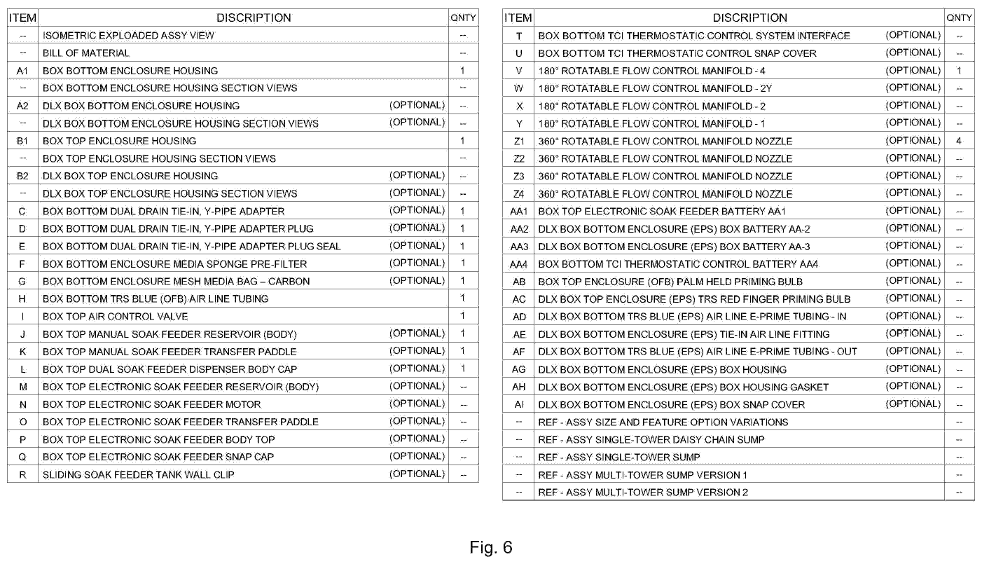

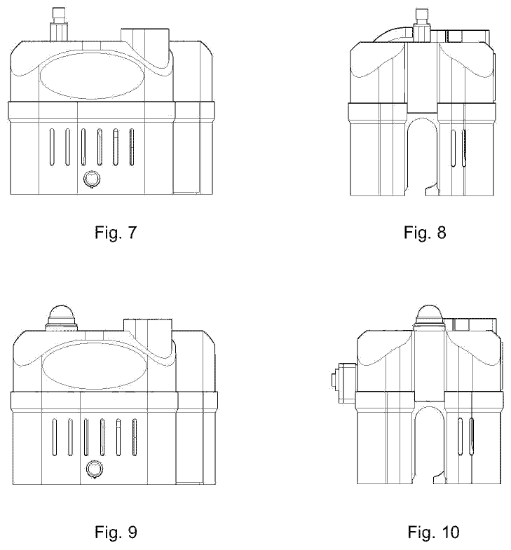

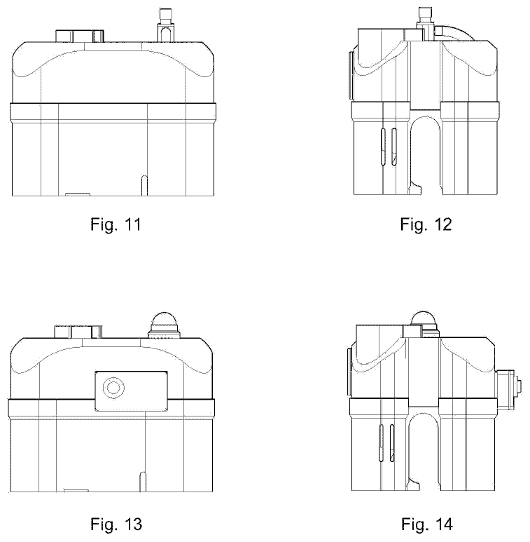

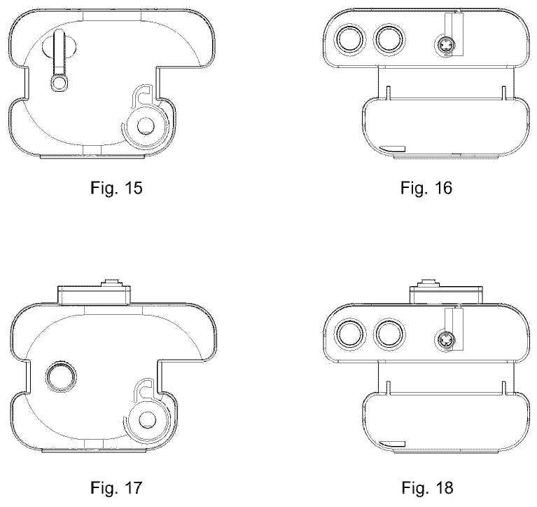

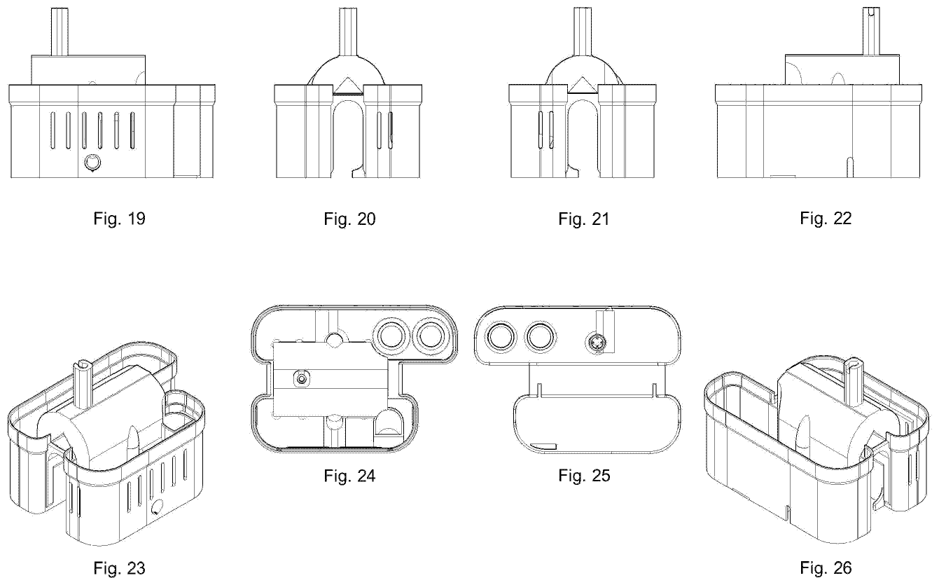

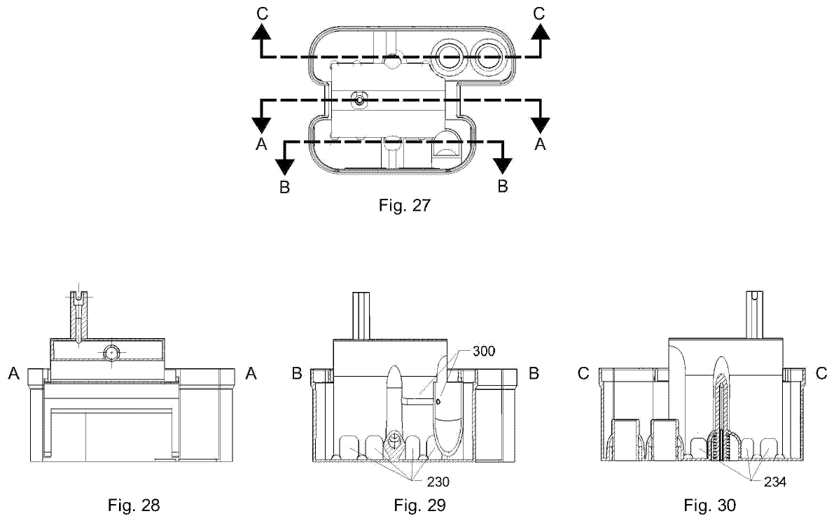

Referring first to all the embodiments in FIGS. 1 and FIG. 2 which are made of a plastic material, preferably black in color, with FIG. 3 J, K, AND L, FIG. 4 M, N, O, P, L and Q, and FIG. 5 similar to FIG. 4, which are constructed of the same plastic material, but preferably red in color, this with the exception of embodiments such as internal electrical parts, motors, pumps, batteries and a clear viewing window.

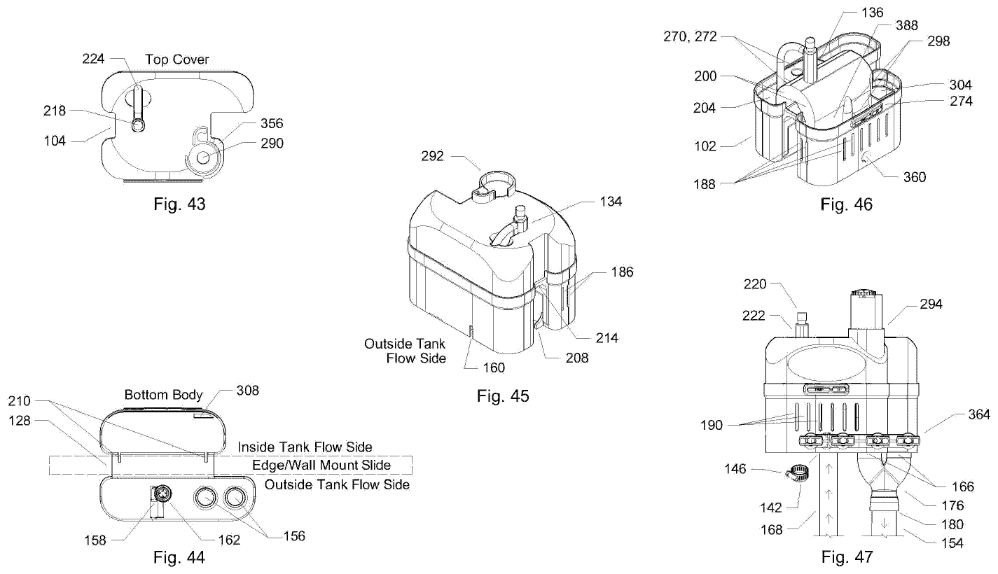

Referring next to FIG. 1, FIG. 46 manual prime over flow box filter version 102, FIG. 43 104, there is a FIG. 2 optional electric prime overflow box filter conversion controller kit version, FIG. 49 108, 110, FIG. 50 106.

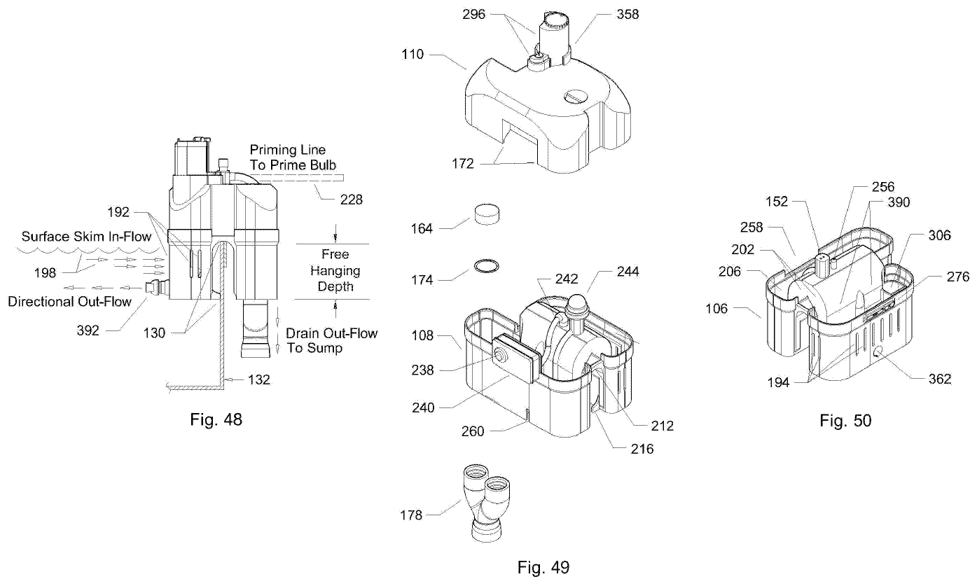

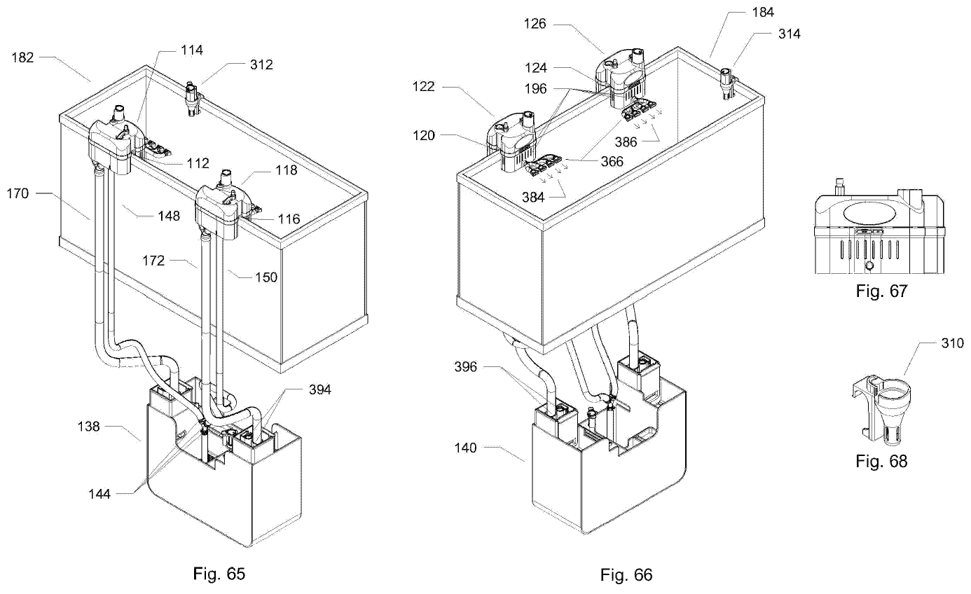

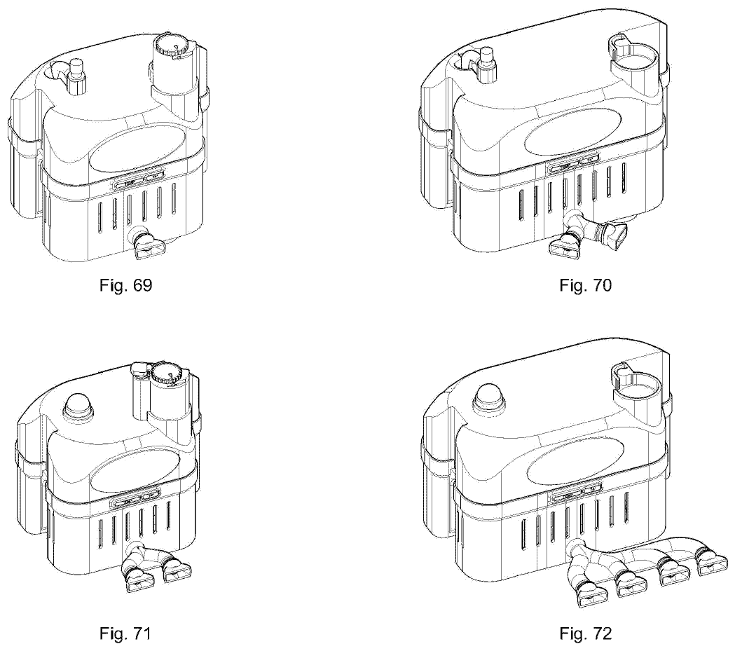

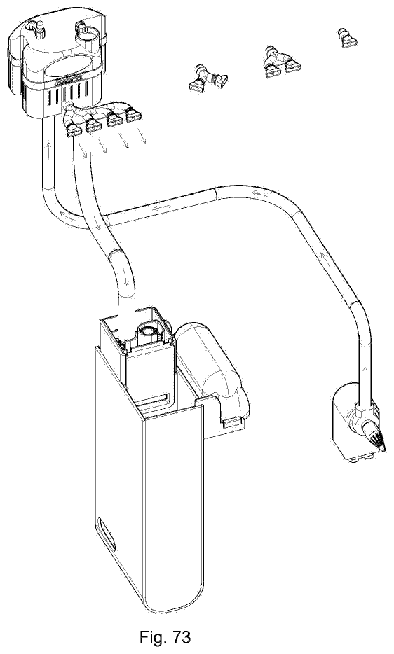

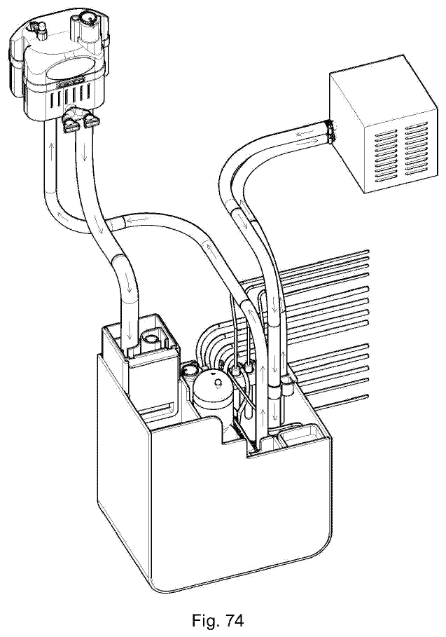

Before securing FIG. 1 and FIG. 2 over flow box filter in a suitable location which provides access to the main tank/habitat chamber containment area, pond or aquarium, (usually at the water's edge), on a stand, bracket, or by straddling the specifically designed unit over the top back wall FIG. 65 112, 114, 116, 118, FIG. 66 120, 122, 124, 126 or the top side wall, FIG. 44 edge wall mount slide 128, FIG. 48 130, 132, remove FIG. 43 top cover housing 104, FIG. 49 110 being similar, and set it aside.

Referring next to FIG. 1, FIG. 46 manual prime over flow box filter version 102, FIG. 43 104, and to FIG. 45 push-on, supply line-in, port adapter connection tower 134, FIG. 46 136. (If FIG. 65 external sump/filter system 138, FIG. 66 140 is not already sump-pump connected and ready to tie into FIG. 1 manual prime over flow box filter version FIG. 46 102, FIG. 43 104, or FIG. 2 optional electric prime overflow box filter conversion controller kit version FIG. 49 108, 110, then Slide a FIG. 47 supply line-in clamp 142, FIG. 65 144 over, and two inches down, onto FIG. 65 external sump/filter system 138, FIG. 66 1140, pump end of FIG. 65 supply line-in pipe tubing 148, 150.

Next, slide FIG. 65 supply line-in pipe tubing 148, 150 onto the sump-pump head supply port or extension of FIG. 65 external sump/filter system 138, FIG. 66 140 and secure it in place using a FIG. 47 supply line-in clamp 142, FIG. 65 144, by using a screwdriver to twist its FIG. 47 supply line-in clamp lock-screw 146, until snug.)

Referring back to FIG. 45 push-on, supply line-in, port adapter connection tower 134, FIG. 46 136, FIG. 46 manual over flow box filter bottom housing 102, and FIG. 50 electronic over flow filter box bottom housing 106, 152 being similar.

Slide FIG. 47 supply line-in clamp 142 over and two inches down on FIG. 65 external sump/filter system supply line-in pipe tubing 148, 150, FIG. 47 154, and FIG. 66 140 being similar.

Next, carefully push/twist-on snugly FIG. 47 supply line-in pipe tubing 154, FIG. 65 148, 150, onto FIG. 44 push-on, supply line-in, port adapter connection 156. Slide FIG. 47 supply line-in clamp 142 up into FIG. 44 supply line-in clamp access slot 158, FIG. 45 160, until it is seated against FIG. 44 over flow box filter bottom housing 162, FIG. 50 106 being similar.

Using FIG. 44 supply line-in clamp access slot 158, FIG. 45 160, take a screwdriver and twist FIG. 47 supply line-in clamp lock-screw 146 until snug. (This completes the installation tie-in for the water supply-in from the external sump/filter system FIG. 65 138, FIG. 66 140, to FIG. 1 manual prime over flow box filter version FIG. 43 104, FIG. 46 102, FIG. 47, with FIG. 2 optional electric prime overflow box filter conversion controller kit version, FIG. 49 108, 110, FIG. 50 106 being typical.)

Referring next to FIG. 44 dual push-n-lock drain line-out connections 156, FIG. 47 166. (These connections are specifically designed to be press fit only, no pipe clamps are required for these connections.)

(If FIG. 65 external sump/filter system 138, FIG. 66 140 is not FIG. 65 already sump drain line-in connected 394, FIG. 66 396, and ready to tie into FIG. 1 and FIG. 2 over flow box filter, then Slide a FIG. 47 standard drain line-in clamp 142, FIG. 144, over and two inches down onto FIG. 65 external sump/filter system 138, FIG. 66 140 sump/filter end of FIG. 65 drain line-out pipe tubing 148, 150.

Next, slide FIG. 65 drain line-out pipe tubing 148, 150, onto the sump drain line-in port connector of FIG. 65 external sump/filter system 138, FIG. 66 140 and secure it in place using FIG. 65 drain line-in clamp/(s) 144 by using a screwdriver to twist its FIG. 47 supply line-in clamp lock-screw 146 until snug.)

Referring back to FIG. 44 dual push-n-lock drain line-out port connections 156, FIG. 47 166.

Carefully push/twist-on snugly, (one or two depending on the external sump/filter configuration), FIG. 47 drain line-out pipe tubing 168, FIG. 65 170, 172 into one or both of FIG. 44 dual push-n-lock drain line-out port connections 156, FIG. 47 166. (If only one FIG. 44 dual push-n-lock drain line-out port connection 156, FIG. 47 166 is desired, install FIG. 49 drain line-out push-on drain port connection plug seal 174, and drain line-out push-on drain port connection plug cap 164, in place atop the unused FIG. 44 dual push-n-lock drain line-out port connection 156, FIG. 47 166.)

When FIG. 47 Y-pipe dual push-n-lock drain line-out port adapter 176, FIG. 49 176 is used for configuring dual drains to FIG. 47 single drain line-out pipe tubing 154, simply push FIG. 47 Y-pipe dual push-n-lock drain line-out port adapter 176, FIG. 49 178, into FIG. 44 dual push-n-lock drain line-out port connections 156, FIG. 47 166 until it is fully seated.

Next, carefully push/twist-on snugly, FIG. 47 drain line-out pipe tubing 154, FIG. 65 170, 172 into the single bottom port connection of FIG. 47 Y-dual push-n-lock drain line-out port adapter 176, 180, FIG. 49 178.

FIG. 49 Y-dual push-n-lock drain line-out port adapter 178 is also specifically designed to be press fit only, no pipe clamps are required for its connections. (This completes the installation process tie-in for the water drain-out from FIG. 1 manual prime over flow box filter version, FIG. 43 104, FIG. 46 102, FIG. 47 166, 176, with FIG. 2 optional electric prime overflow box filter conversion controller kit version, FIG. 49 108, 110, FIG. 50 106 being typical, to FIG. 65 external sump/filter system 138, FIG. 66 140.)

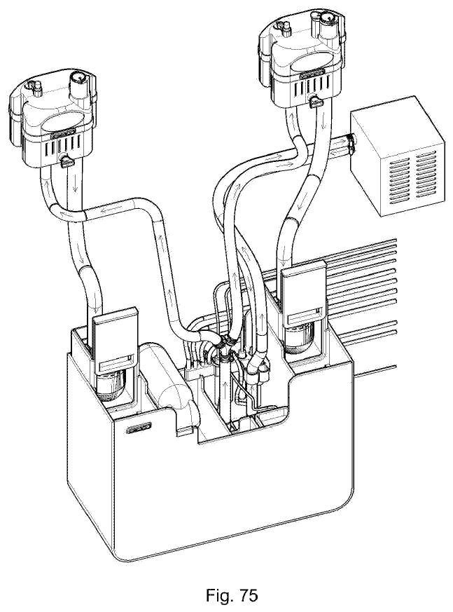

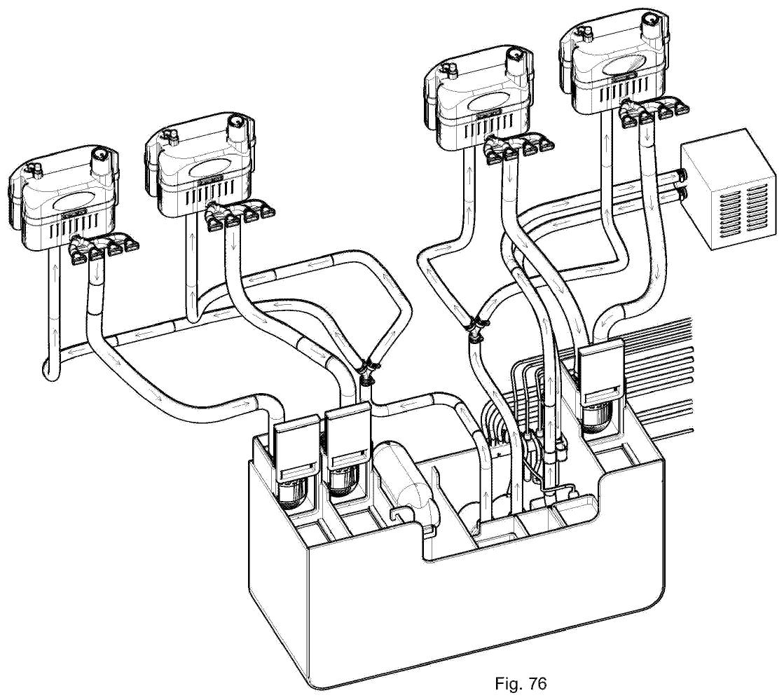

When configuring multiple FIG. 65 over flow box filter units 114, 118, FIG. 66 122, 126, and having FIG. 44 156, FIG. 47 166, FIG. 65 170, 172, two, four, six or eight drains available FIG. 65 394, FIG. 66 396, allows for the creation of a “redundancy” type of FIG. 75 multiple over flow box filter system FIG. 76 framework, which increases the system's protection against overfilling of FIG. 65 main tank/habitat chamber containment area 182, FIG. 66 184, should any FIG. 44 156, FIG. 47 166, single drain become clogged or fail for some reason during use.

When multiple FIG. 65 over flow box filter units 114, 118, FIG. 66 122, 126, are used, this simultaneously decreases each FIG. 44 individual drains 156, FIG. 47 166, FIG. 65 170, 172, capacity limits for the total drainage of the overall main tank/habitat chamber containment area, while increasing the reliability and stability of the overall drainage system FIG. 65, 394, FIG. 66 396.

Now, with FIG. 65 supply line-in pipe tubing 148, 150, and FIG. 65 drain line-out pipe tubing 170, 172 securely in place, lower FIG. 46 overflow box filter bottom housing 102, FIG. 50 106, into position so that it sits FIG. 48 any rim, tank or edge wall 130, 132, FIG. 44 128, levelly on FIG. 65 both the inside and outside of the main tank/habitat chamber containment area 112, 114, 116, 118, and FIG. 66 120, 122, 124, 126.

Referring next to FIG. 45 top surface water skimming slots 186, FIG. 46 188, FIG. 47 190, FIG. 48 192, FIG. 50 194, FIG. 66 196, all inflow slots should automatically reside at least 70 percent submerged within FIG. 48 main tank/habitat chamber containment area's skimmed upper water column area 198, while the unit itself FIG. 1, FIG. 2 over flow box filter, faces forward so that FIG. 48 main tank/habitat chamber containment area's skimmed upper water column area 198 can then enter the unit freely and initial water processing may begin via FIG. 46 over-the-wall water transfer chase construction 200, FIG. 50 202 and into FIG. 46 rear sump area 204, FIG. 50 206 of FIG. 46 over flow box filter bottom housing 202, FIG. 50 106.

The FIG. 45 self-leveling support tabs 208, FIG. 44 210, FIG. 48 130, 49 212 provide balance and stability while FIG. 44 self-leveling edge/wall slide 128, FIG. 45 214, FIG. 49 216 keeps FIG. 1, FIG. 2 over flow box filter automatically level on FIG. 48 any rim, tank or edge wall 130, 132.

Referring next to the manual priming system, FIG. 43 priming air-control valve 218, FIG. 47 220, which is connected to FIG. 45 push-on, supply line-in, port adapter connection tower 134, FIG. 47 222 and FIG. 43 priming line, air-control valve tubing 224 and then to FIG. 57 priming line siphon bulb 226 which can then be squeezed to begin manual priming.

With FIG. 43 top cover housing 104, FIG. 49 110 still removed, plug in and switch on the power to FIG. 65 external sump/filter system 138, FIG. 66 140. Use two fingers to pull up and free the end of FIG. 43 priming line, air-control valve tubing 224 which is located down inside FIG. 46 rear sump area 204 of FIG. 46 over flow box filter bottom housing 102.

Connect FIG. 57 priming line siphon bulb 226 to the free end of FIG. 43 priming line, air-control valve tubing 224, FIG. 48 228, which can then be manually squeezed to begin priming.

With the use of a cup or container, transfer a small amount of water into FIG. 46 rear sump area 204 of FIG. 46 over flow box filter bottom housing 102 until the water level rises up and breaches FIG. 44 dual push-n-lock drain line-out port connections 156, FIG. 47 166.

Discontinue adding additional water when the over flow water begins to travel freely down FIG. 47 drain line-out pipe tubing 154, FIG. 65 170, 172.

Turn FIG. 43 priming valve 218 counter-clockwise several times to open up the valve completely. Now squeeze FIG. 57 priming line siphon bulb 226 multiple times until the main tank/habitat chamber containment area water in FIG. 65 main tank/habitat chamber containment area 182, FIG. 66 184, begins entering the front of FIG. 46 over flow box filter bottom housing 102 via its front and side FIG. 46 top surface water skimming slots 188, FIG. 48 192, FIG. 66 196.

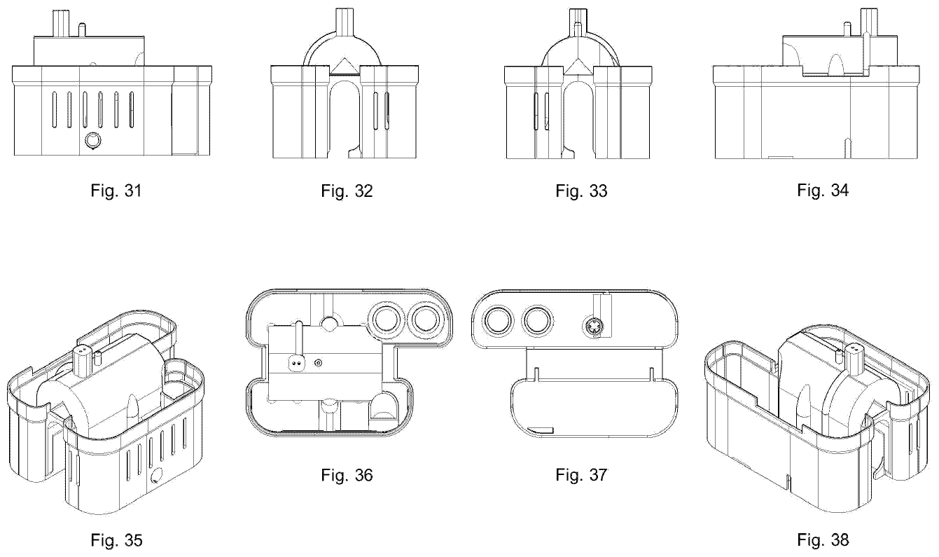

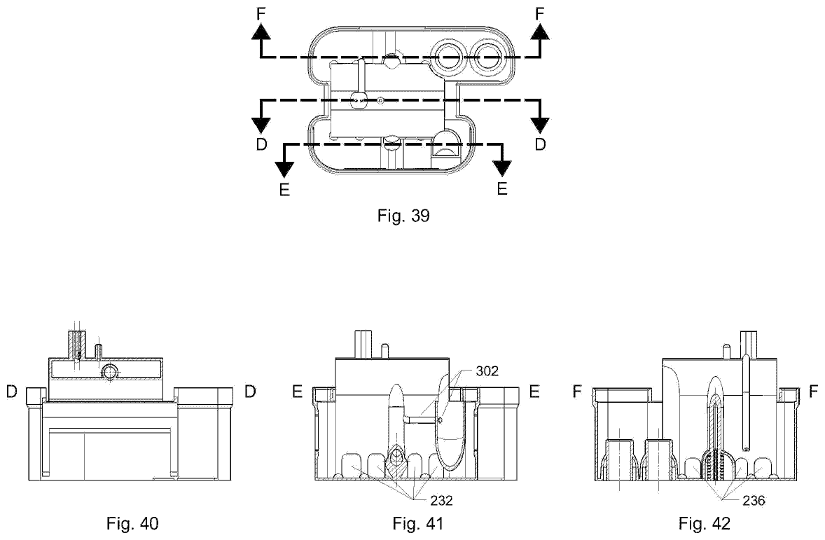

Once the water passes into the front of FIG. 46 over flow box filter bottom housing 102, it is drawn up, and into, the FIG. 29 inflow slot/(s) 230, FIG. 41 232, located at the front base of FIG. 46 over-the-wall water transfer chase construction 200, then up and over FIG. 65 main tank/habitat chamber containment area wall 112, 116, FIG. 66 120, 124, and then down and out through FIG. 30 outflow slot/(s) (section C-C) 234, FIG. 42 (section F-F) 236, located at the rear base of FIG. 46 over-the-wall water transfer chase construction 200, and into FIG. 46 rear sump area 204 of FIG. 46 over flow box filter bottom housing 102.

When FIG. 45 priming tower 134, FIG. 46 136, FIG. 47 222, and FIG. 43 priming line, air-control valve tubing 224 show the appearance of water and there are no air bubbles present in FIG. 43 priming line, air-control valve tubing 224, FIG. 48 228, then turn FIG. 43 priming air-control valve 218, FIG. 47 220, clockwise several times to close the valve completely.

Disconnect FIG. 57 priming line siphon bulb 226, from FIG. 43 priming line, air-control valve tubing 224, FIG. 48 228, and set it aside. Return the free end of FIG. 43 priming line, air-control valve tubing 224, FIG. 48 228, back into its original location down within FIG. 46 rear sump area 204 of FIG. 46 over flow box filter bottom housing 102.

With the manual priming system now fully primed and being continuously gravity fed, the water in FIG. 65 main tank/habitat chamber containment area 182, FIG. 66 184, will flow through to FIG. 46 rear sump area 204 of FIG. 46 over flow box filter bottom housing 102 unheeded.

Look at, and carefully run the tip of your finger around all external connections to check for any evident leaks or seepage that might be present. Continue this process as you follow the path of the water as it travels down to FIG. 65 external sump/filter system 138, FIG. 66 140. Address any leaks or seepage by tightening any loose connections and recheck. If no leaks or seepage is present, proceed to the next step.

Referring next to the optional electronic priming system, FIG. 49 108, 110, 238, 240, 242, 244, which incorporates FIG. 60 finger prime push button with bubble check, FIG. 61 batteries 264, and FIG. 62 electric prime embodiment with automatic prime push button on/off switch.

Connect the free end of FIG. 62 auto prime siphon line-in 250 to FIG. 62 siphon line bottom box connector 252, which in turn is mounted to FIG. 50 siphon line-in tower nipple fitting 256, FIG. 49 242.

Allow FIG. 63 auto prime siphon drain/weep line 254, to be lowered into the rear of FIG. 50 box bottom housing 106, 206, after FIG. 63 auto priming box, is slid onto FIG. 50 auto priming box mounting slot 258, FIG. 49 238, 260.

Once assembled, FIG. 60 finger prime push button with bubble check 262, FIG. 49 244, which is used to check for air seepage into the auto priming system, and can be installed on FIG. 50 auto siphon line connecting tower 152, FIG. 49 244, to complete the optional electronic priming system.

Use a cup or container to transfer a small amount of water into FIG. 50 rear sump area 206 of FIG. 50 over flow box filter bottom housing 106, until the water level rises up and breaches FIG. 44 dual push-n-lock drain line-out port connections 156, FIG. 47 166.

Discontinue adding additional water when the over flow water begins to travel freely down FIG. 47 drain line-out pipe tubing 154, FIG. 65 170, 172.

Press in FIG. 62 electric priming box automatic prime push button on/off switch 246, FIG. 49 240, until the main tank/habitat chamber containment area in FIG. 65 main tank/habitat chamber containment area 182, FIG. 66 184, begins entering the front of FIG. 50 over flow box filter bottom housing 106, via its front and side FIG. 50 surface skim slots 194, FIG. 48 192, 198.

Once the water passes into the front of FIG. 50 over flow box filter bottom housing 106, the water is drawn up and over FIG. 50 over-the-wall water transfer chase construction 202, and then into FIG. 50 rear sump area 206, of FIG. 50 over flow box filter bottom housing 106.

When FIG. 50 over-the-wall water transfer chase construction 202, and FIG. 50 rear sump area 206, of FIG. over flow box filter bottom housing 106, are flowing freely, discontinue pressing on FIG. 62 electric priming box automatic prime push button on/off switch 246, FIG. 49 240, completely.

Next, press down on FIG. 60 finger prime push button with bubble check 262, FIG. 49 244, repeatedly to verify that no air is present within FIG. 50 over-the-wall water transfer chase construction 202. When no air bubbles show to be present, the optional electronic system is primed.

Check back periodically and press down on FIG. 60 finger prime push button with bubble check 262, FIG. 49 244, to occasionally verify that no air has accumulated within FIG. 50 over-the-wall water transfer chase construction 202, over time.

With both the FIG. 43 manual priming system 218, 224, FIG. 46 136, 200, FIG. 57 226, and FIG. 49 optional electronic priming system 108, 110, 240, 242, 244 FIG. 50 152, 202, 256, now fully primed and being continuously gravity fed, the water in FIG. 65 main tank/habitat chamber containment area 182, FIG. 66 184, will flow over the wall to FIG. 65 external sump/filter system 138, FIG. 66 140, as fast as the pump from FIG. 65 external sump/filter system 138, FIG. 66 140, can circulate the water back into FIG. 65 main tank/habitat chamber containment area 182, FIG. 66 184.

Referring next to FIG. 58 sponge mesh pre-filter 266 and FIG. 59 carbon media pre-filter 268.

First insert FIG. 58 sponge mesh pre-filter 266 into the middle of FIG. 46 rear sump area 204, 270, of FIG. 46 over flow box filter bottom housing 102, with FIG. 49 optional electric prime overflow box filter conversion controller kit version 108, 110, FIG. 50 106, being typical.

Once in place, insert FIG. 59 carbon media pre-filter 268 directly on top of FIG. 58 sponge mesh pre-filter 266, FIG. 46 rear sump area 270, 272, with FIG. 50 optional electric prime overflow box filter conversion controller kit version 106, being typical.

With both FIG. 58 sponge mesh pre-filter 266 and FIG. 59 carbon media pre-filter 268, FIG. 46 270, 272, stacked in place, the process water now flows through FIG. 46 sponge mesh pre-filter 270, FIG. 58 266, which adds mechanical filtration to the system, and at the same time, the water also flows through FIG. 46 carbon media pre-filter 272, FIG. 59 268, which adds chemical filtration to the system.

Referring next to FIG. 46 thermostatic control interface 274, FIG. 50 276, FIG. 64 278, 280, 282, 284, 286, 288, an interactive readout device which provides a display of the active water quality conditions such as, but not limited to, temperature, conductivity, redox-orp, and nitrite/nitrate levels. Current readings are available at the touch of a button, FIG. 64 282 via FIG. 64 digital status report screen 284, which are sent from signals provided by FIG. 64 sensors, diodes and probes 280.

The FIG. 64 thermostatic control interface, is powered by FIG. 64 battery 286 which can be replaced by (with FIG. 43 top cover housing 104, FIG. 49 110 still removed) use a sharp edge or fingernail to remove the embodiment's FIG. 64 thermostatic control interface rear snap cover 288 and pry free with the same sharp edge or fingernail, the old FIG. 64 battery 286, replacing it with a new FIG. 64 battery 286, before snapping FIG. 64 thermostatic control interface rear snap cover 288, back in place.

Referring back to FIG. 43 top cover housing 104, FIG. 110, still removed. Replace the FIG. 43 top cover housing 104, FIG. 49 110, with FIG. 55 manual soak feeder attachment, or FIG. 56 automatic soak feeder attachment, so that FIG. 43 priming air-control valve 218, FIG. 47 220, which is connected to FIG. 45 priming tower 134, and FIG. priming line, air-control valve tubing 224, FIG. 48 228, or FIG. 60 finger prime push button with bubble check 262, FIG. 49 244, are easily accessible from outside of FIG. 43 top cover housing 104, FIG. 49 110.

Referring next to FIG. 43 top-off fill port and soak feeder assembly port 290, FIG. 45 292, FIG. 47 294, FIG. 49 296, which allows the aquarist to bypass pouring fill or top-off water, directly into FIG. 65 main tank/habitat chamber containment area 182, FIG. 66 184, or FIG. 65 external filter system 138, FIG. 66 140, (avoiding the locations of lights, filters and glass or acrylic tops), and adding fill, top-off water, or water treatments and additives, directly into FIG. 65 main tank/habitat chamber containment area 182, FIG. 66 184, via FIG. 43 overflow box filter top enclosure 104, FIG. 49 110, where they are cyclonically premixed by direct water injection via FIG. 46 cyclonic supply-in pipe head release port 298, FIG. 29 (Section B-B) 300, FIG. 41 (Section E-E) 302, FIG. 46 304, FIG. 50 306, where they are spun and soaked prior to their release from FIG. 44 submerged top-off water fill, additive, and food release port 308, FIG. 50 optional electronic over flow box filter bottom 106, being typical.

Referring next to FIG. 55 optional manual soak feeder attachment, and FIG. 56 optional automatic soak feeder attachment, of which both FIG. 55, and FIG. 66, embodiments can also be mounted entirely separately on FIG. 68 optional sliding soak feeder tank wall clip 310, FIG. 65 312, FIG. 66 314.

The later, FIG. 56 optional automatic soak feeder attachment, is powered by placing FIG. 56 battery 350, FIG. 264, into the FIG. 56 automatic soak feeder attachment main body housing 318, by lifting FIG. 56 automatic soak feeder battery cover snap cap 352, 354, and sliding the FIG. 56 battery 350, FIG. 61 264, negative end first, into FIG. 56 automatic soak feeder attachment main body housing 318, and then returning FIG. 56 automatic soak feeder battery cover snap cap 352, 354, back into the closed position atop FIG. 56 automatic soak feeder attachment main body housing 318.

The FIG. 56 automatic soak feeder attachment main body housing 318, has two settings that are identified by FIG. 56 automatic soak feeder attachment main body housing power indicator lite setting one 342, which provides food on a 12-hour cycle, or twice daily and FIG. 56 automatic soak feeder attachment main body housing power indicator lite setting two 344, which provides food on an 8-hour cycle, or three time daily.

Either of the two automatic feeder settings can be activated by turning FIG. 56 automatic soak feeder attachment main body housing cap 338, power indicator arrow 348, which is located on top of FIG. 56 automatic soak feeder attachment main body housing cap 338, to FIG. 56 automatic soak feeder attachment main body housing power indicator lite setting one 342, or FIG. 56 automatic soak feeder attachment main body housing power indicator lite setting two 344, respectfully, for the desired feeding schedule to be obtained.

The FIG. 55 optional soak feeder attachment main body housings of both soak feeder embodiments 316, FIG. 56 318, can be clipped onto, and rest upon, either of FIG. 43 overflow box filter embodiments' top-off fill port and soak feeder assembly ports 356, FIG. 45 292, FIG. 47 294 and FIG. 49 358, in order to allow the aquarist to bypass pouring food directly into FIG. 65 main tank/habitat chamber containment area 182, FIG. 66 184, or FIG. 65 external filter system 138, FIG. 66 140, (avoiding the locations of lights, filters and glass or acrylic tops), and adding food directly into FIG. 65 main tank/habitat chamber containment area 182, FIG. 66 184, via FIG. 43 overflow box filter top enclosure 104, FIG. 49 110, where they are cyclonically premixed by direct water injection via FIG. 29 cyclonic supply-in pipe head release port (Section B-B) 300, FIG. 41 (Section E-E) 302, FIG. 46 304, FIG. 50 306, where the food is spun and pre-soaked prior to its release from FIG. 44 submerged top-off water fill, additive, and food release port 308, FIG. 50 optional electronic over flow box filter bottom 106, being typical.

By removing the FIG. 55 optional soak feeder attachment main body caps 336, FIG. 56 338, from their associated FIG. 55 optional soak feeder attachment main body housings 316, FIG. 56 318, it is then possible to pour food directly into FIG. 55 soak feeder attachment main body housing 316, FIG. 56 318, chambers FIG. 55 324, 328, and FIG. 56 326, 330, with their FIG. 55 optional soak feeder attachment main body housing paddles 320, FIG. 56 322, still in place, until their FIG. 55 optional soak feeder attachment main body housing chambers 324, 328, and FIG. 56 326, 330, are full.

Allow room for the re-seating of FIG. 55 optional soak feeder attachment main body housing cap 336, or FIG. 56 optional automatic soak feeder attachment main body housing cap 338.

Referring back to FIG. 55 optional manual soak feeder attachment main body housing cap 336.

Once FIG. 55 optional manual soak feeder attachment main body housing chamber 324, 328, is full, and FIG. 55 optional manual soak feeder attachment main body housing cap 336 is replaced so that it clicks in place atop FIG. 55 optional manual soak feeder attachment main body housing paddles 320, the FIG. 55 optional manual soak feeder attachment main body housing cap 336, can be twisted back and forth, or rotated completely around 180 degrees, until FIG. 55 optional manual soak feeder attachment main body housing cap arrow 346, returns back to its original indicator position FIG. 55 340.

The twisting action of both FIG. 55 optional soak feeder attachment main body housing paddles 320, FIG. 56 322, dispenses a premeasured serving of food from either of the FIG. 55 optional soak feeder attachment main body housing holes 332, FIG. 56 334, which are located in the bottoms of FIG. 55 optional soak feeder attachment main body housings 316, FIG. 56 318.

Once the premeasured food is released from FIG. 55 optional soak feeder attachment main body housing holes 332, FIG. 56 334, the food enters, and then falls down, to follow the same path through the FIG. 46 overflow box filter bottoms' internal cyclonic pre-soak food and top-off water pre-release chambers 304, FIG. 50 306, before reaching FIG. 44 manual prime over flow box filter bottom's submerged top-off, water fill, additive, and food pre-soak release port 308, (FIG. 50 electronic prime over flow box filter bottom being typical), as the added top-off fill water does prior to its release into FIG. 65 main tank/habitat chamber containment area 182, FIG. 66 184.

Added science: The swim bladder, or air bladder, is a buoyancy organ which most fish have. The swim bladder is located in the body cavity of the fish, and is derived from an out-pocketing of the digestive tube. This organ contains oxygen and functions similarly to a hydrostatic, or ballast.

The organ also enables fish to maintain their depth within the main tank/habitat chamber containment area water column, without upward floating or the opposite, a slow sinking effect.

By using the submerged soak feeder features of the over flow box filter, the aquarist can now reduce fluctuations in the buoyancy of their fish by eliminating the top water feeding habits which in many cases, causes the submerged feeding animals, (which normally feed mid-level or the bottom), to gulp in excessive air when they are higher up in the water column and surface feeding. This extra air can then enter their bladders, become trapped, and cause buoyancy issues and stress.

By submerging and pre-soaking any added food prior to its delivery into the main habitat area, and the food being offered out to these types of lower feeding creatures, the overall health and nourishment of the animals is better guaranteed.

There is also the inherent benefit of having any food or additive which arrives pre-submerged into the main tank/habitat chamber containment area circulate down lower into the water column where most animals tend to feed. This being a much more practical application for feeding than having the food or additive float across the water column top surface where it can rapidly bypass the main tank/habitat chamber containment area altogether, and be introduced into top surface skimmers, corner boxes, and/or other standard tank filters.

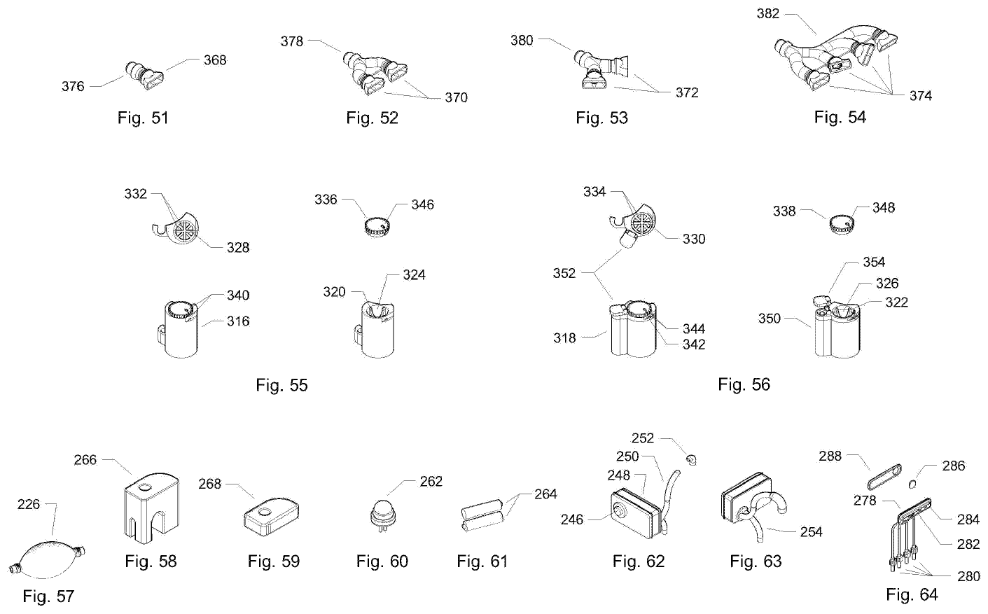

Referring next to FIG. 46 keyed front mounting port 360, FIG. 50 362, which is designed, keyed and sized to hold a variety of FIG. 51-54 keyed bi-directional powerhead manifold embodiments, which can FIG. 47 key-lock in a level position 364, or FIG. 66 rotated 180 degrees 366, as well as the ability of FIG. 46 keyed front mounting port 360, FIG. 50 362, to hold aftermarket powerhead assemblies.

Connected to FIG. 51 keyed bi-directional powerhead manifold 368, FIG. 52 370, FIG. 53 372 and FIG. 54 374, are FIG. 51 adjustable powerhead manifold flow nozzles 376, FIG. 52 378, FIG. 53 380, and FIG. 54 382, that can FIG. 54 rotate 360 degrees 374, on their own, along with swiveling off at a multitude of offset directions which enable them to provide FIG. 65 main tank/habitat chamber containment area 182, FIG. 66 184, with FIG. 47 incoming water flow 364, FIG. 66 366, 384, 386, same as FIG. 48 392, directed in the most preferred directions for the optimal support of fish, plant and coral growth.

By scaling down the overall system to a more user-friendly level, the average aquarist can now have access to one of the most powerful large scale filtration system platforms, and also acquire it in a version which readily supports the much smaller (nano type) mini aquatic environments that are so popular today.

Modern “nano” environments may start off in as low as the five to ten-gallon range. Incorporating an over flow box filter provides the end user with the ability to switch from FIG. 47 smaller sized unit, to a FIG. 67 larger sized unit, as their overall filtration system and water volumes increase.

Nearly hands free to operate, and produced with state-of-the-art construction and design, the over flow box filter system includes all the built-in technology, hardware and science needed for the feeding, monitoring, top-off and external transfer of water in the support of any plant or animal contained in a freshwater, brackish-water or saltwater containment area such as a pond, stream, sump tank, display tank, refugium and/or aquarium.

The over flow box filter is designed to automatically “self-prime”, and then “restart” again by itself, (without any manual or electronic priming), should the power to the external system pump shut off at any time, and then turn back on.

Periodically check the priming system for any oxygen build up. This is especially important after any external pump failure or power outage has taken place.

If for some reason the main over flow box filter system should get clogged by debris, or stop flowing altogether, it is suggested that FIG. 65, two or more of the units, FIG. 66, be used in tandem to create a “redundant” system. Should one of the over flow box filters fail in the transfer of water for any reason, then the other unit or units will provide sufficient drainage to the overall over flow box filter system until the issues with the main unit can be addressed.

Referring next to FIG. 44 dual push-n-lock drain line-out connections 156, FIG. 47 166, FIG. 50 106 being typical, it should be noted that the total incoming “pump head flow” which enters the FIG. 65 main tank/habitat chamber containment area 182, FIG. 66 184, 384, 386, should not exceed 80 percent of a single unit FIG. 44 dual push-n-lock drain line-out connections 156, FIG. 47 154, 166, FIG. 50 106 being typical, full dual drain capacity.

Referring again to FIG. 46 top surface water skimming slots 188, FIG. 47 190, FIG. 48 192, FIG. 50 194 and FIG. 66 196, after continuous surface skimming by the unit, the unfiltered FIG. 48 main tank/habitat chamber containment area water 198, being gathered up from FIG. 65 main tank/habitat chamber containment area 182, FIG. 66 184, begins to travel from the FIG. 46 top surface water skimming slots 188, FIG. 47 190, FIG. 48 192, FIG. 50 194 and FIG. 66 196, and to fill up FIG. 46 over flow box filter front box area 388, FIG. 50 390, until its surface water height is equal to that of FIG. 48 internal main tank/habitat chamber containment area surface water level 198.

Here the water flows from inside of, to outside of, FIG. 65 main tank/habitat chamber containment area 182, FIG. 66 184, via the siphoning effect provided by the FIG. 46 over-the-wall transfer chase tube wall construction 200, FIG. 50 202.

The water flow then continues out to FIG. 44 dual push-n-lock drain line-out connections 156, FIG. 47 166, main return drain/(s) FIG. 47 154, which are located FIG. 46 rear sump area 204, FIG. 50 206 on the bottom right, rear side, of FIG. 46 over flow box filter bottom housing 102, FIG. 50 106, before finally draining out to FIG. 65 external sump/filter system 138, FIG. 66 140 for external processing.

The FIG. 46 top surface water skimming slots 188, FIG. 190, FIG. 48 192, FIG. 50 194 and FIG. 66 196, are capable providing non-stop surface skimming twenty-four hours a day. This action in turn, continuously removes all the contaminants trapped within the upper layers of the FIG. 65 main tank/habitat chamber containment area 182, FIG. 66 184, area water column, before then transferring that pre-cycled water out to FIG. 65 external sump/filter system 138, FIG. 66 140 for processing and revitalization.

This process of continual water transference, prevents the normal buildup of harmful contaminants such as algae blooms, nitrites, nitrates, PH imbalances, detritus and other biological waste that regularly accumulate within FIG. 65 main tank/habitat chamber containment area 182, FIG. 66 184, and often can offset the long-term stability of the water quality within the entire system.

The gain of aquatic load, (or cycle), as it takes place, frequently makes the FIG. 65 main tank/habitat chamber containment area 182, FIG. 66 184, containment area itself, detrimental to the plants and animals that reside within it.

Once the FIG. 65 external sump/filter system 138, FIG. 66 140, completes its initial processing of the FIG. 65 main tank/habitat chamber containment area 182, FIG. 66 184, and just as fast as the FIG. 65 external sump/filter system 138, FIG. 66 140 pump, can return the water flow back and into the over flow box filter via FIG. 44 push-on, supply line-in, port adapter connection tube 162, FIG. 50 106 being typical, where the returned in-flow will then travel in and back over the FIG. 46 over-the-wall transfer chase tube wall construction 200, FIG. 50 202, and into the FIG. 46 keyed front mounting port 360, FIG. 50 362, where one of the FIG. 51-54 keyed bi-directional powerhead manifold embodiments, FIG. 47. 364, FIG. 48 392 can be mounted to provide the appropriate water intake and direction of flow within the FIG. 65 main tank/habitat chamber containment area 182, FIG. 66 184.

While being continuously fed, the water is recirculated again and again up, over, out, and down into the FIG. 65 external sump/filter system 138, FIG. 66 140, or other compatible system for its reprocessing, before once more being returned to FIG. 65 main tank/habitat chamber containment area 182, FIG. 66 184.

The circulation pattern from FIG. 65 main tank/habitat chamber containment area 182, FIG. 66 184, through FIG. 45 over flow box filter, FIG. 49, and then to FIG. 65 external sump/filter system 138, FIG. 66 140, continues twenty-four-seven.

Scientifically designed and constructed, the FIG. 45 over flow box filter FIG. 49, whether manually primed or electronically primed, will run quietly in the background while providing all levels of aquarists with the peace of mind they deserve.

1. In an over flow box filter made to support the transfer of water from a pond, stream, tank, sump, or main tank/habitat chamber containment area to an outside external filter system for processing, which then pumps the water back again to the main tank/habitat chamber containment area via the same over flow box filter and comprised of:
An over flow box filter available in both a manual prime and automatic prime controller version which is ready to install and mount onto any existing tank rim, edge or lip;
said over flow box filter having a window or clear port on the outside to allow for the viewing of the unit's inner workings;
said over flow box filter having a front lower portion that hangs freely over the tank wall separator and straddles the inner side of any tank rim, edge or lip, and while submerged within the main tank/habitat chamber containment area, faces forward and outward and into the main tank/habitat chamber containment area;
said over flow box filter having a rear lower portion that straddles just the opposite, and is located outside of the main tank/habitat chamber containment area while hanging freely over the tank wall separator, in the air, and facing away from any supporting tank rim, edge or lip;
wherein supply water is transferred from an external filter system pump, and into an external connection supply inflow port, which is located on the outside of the over flow box filter which is then piped internally within a return in-flow over-the-wall pipe chase tube wall construction, supply-in pipe, which is located inside of the over flow box filter and piped through to the front of the over flow box filter. All water then being released into the main tank/habitat chamber containment area of the tank or vessel via the same internal return flow over-the-wall pipe chase tube wall construction, supply-in pipe;
said over flow box filter over-the-wall pipe chase tube wall construction, supply-in pipe, water in-flow is then injected into the main tank/habitat chamber containment area once it reaches the opposite pipe-end of the supply-in pipe, and out flow port which is located in the front of the over flow box filter;
said over flow box filter having on the main tank/habitat chamber containment area side, a sequence of top surface skimming slots which allows for a continuous intake of the main tank/habitat chamber containment area water at the same rate that the external filter pump supplies it, this insuring that the internal main tank/habitat chamber containment area never over fills;
flow taken into the front of the over flow box filter by the array of top surface skimming slots is then transferred out of the front chamber side of the over flow box filter and into the rear drainage chamber via an over-the-wall pipe chase tube wall construction;
wherein the water flow that is siphoned in, up, and over the over-the-wall pipe chase tube wall construction, and emerges in the rear drainage side of the over-the-wall pipe chase tube wall construction, is readily returned to the outside external filter system via the drain/(s) located in the lower rear portion of the over flow box filter which straddles the opposite, or outside face, of any tank rim, edge or lip;
Said drains having at least one or more push-lock connections for external drainage and ease of installation.

2. The apparatus of claim 1, wherein the layout comprises a method for the combined use of a sponge pre-filter which adds mechanical filtration to the system, and a carbon media pre-filter which adds chemical filtration to the system;
said apparatus of claim 2, sponge pre-filter being positioned in either or both, the incoming water flow of the apparatus of claim 1, front internal side of the over flow box filter, or the outgoing water flow side of the apparatus of claim 1, back internal drain side of the over flow box filter;
said apparatus of claim 2, carbon media pre-filter being positioned in either or both, the incoming water flow of the apparatus of claim 1, front internal side of the over flow box filter, or the outgoing water flow side of the apparatus of claim 1, back internal drain side of the over flow box filter.

3. The apparatus of claim 1, wherein the layout comprises a manual prime version of the over flow box filter, in addition to an optional alternate electronic prime overflow box filter conversion controller kit version;
said versions both being prepped for operation by first verifying that the main tank/habitat chamber containment area of the tank or vessel being used contains an internal water level which is high enough to penetrate at least seventy percent of the apparatus of claim 1, top water skim slot/(s);
wherein said main tank/habitat chamber containment area water level will ensure that this side of the apparatus of claim 1, internal front section of the lower portion that hangs freely over the tank wall separator and straddles the inner side of any tank rim, edge or lip, is fully saturated;
said main tank/habitat chamber containment area water level should submerge the lower inflow slot/(s) of the of the apparatus of claim 1, over-the-wall pipe chase tube wall construction completely;
after the introduction or transfer of a small portion of water into the apparatus of claim 1, outside drain section of the over flow box filter which is located in the lower rear portion of the over flow box filter which straddles the opposite, or outside face, of any tank rim, edge or lip, until the water added begins to flow into the apparatus of claim 1, rear drain/(s), this will ensure that this side of the internal back section of the apparatus of claim 1, lower portion of the over flow box filter that hangs freely over the tank wall separator and straddles the outer side of any tank rim, edge or lip, is fully saturated, the internal water level then submerging the lower outflow slot/(s) of the of the apparatus of claim 1, over-the-wall pipe chase tube wall construction completely;
said apparatus of claim 1, over-the-wall pipe chase tube wall construction, creates a self-leveling or equalization effect between both the apparatus of claim 1, front supply side of the over flow box filter and the apparatus of claim 1, back drain side of the over flow box filter;
said apparatus of claim 1, manual prime version of the over flow box filter, being primed via the siphoning action which is provided by the apparatus of claim 3, priming bulb, that is connected to the apparatus of claim 3, external airline tube, which in turn is connected to the apparatus of claim 3, control valve, the latter being plumbed into the top of the apparatus of claim 1, over-the-wall pipe chase tube wall construction and readily accessible from outside of the over flow box filter;
wherein the apparatus of claim 3, the control valve is set to the open position, all the air contained in the apparatus of claim 1, over-the-wall pipe chase tube wall construction can be drawn out;
once said air contained in the apparatus of claim 1, over-the-wall pipe chase tube wall construction is removed and water appears in the apparatus of claim 3, external airline tube, which in turn is connected to the apparatus of claim 3, air control valve, turn the air control valve to the closed position to seal off the manual priming system;
with the apparatus of claim 3, manual priming system now primed, sealed, and closed, should the water supply or the power to the external supply pump shut off for any reason, the apparatus of claim 1, raised drain lip/(s) which are located in the rear of the over flow box filter, and the apparatus of claim 1, raised surface skim slots located on the main tank/habitat chamber containment area side of the over flow box filter, will keep the apparatus of claim 1, over-the-wall pipe chase tube wall construction's inflow and lower outflow slot/(s) fully submerged;
said self-leveling or equalization effect between both the apparatus of claim 1, front supply side of the over flow box filter and the apparatus of claim 1, back drain side of the over flow box filter will discontinue providing flow and sit fully primed while stationed at an idle, until the power to the external filter pump is restored, and the supply-in flow to the apparatus of claim 1, over flow box filter external connection supply inflow port is returned;
once powered up again, the apparatus of claim 3, manual priming system automatically begins with its gravity water feed from the apparatus of claim 1, sequence of top surface skimming slots, and water circulation continues;
said water then travels up and over the apparatus of claim 1, over-the-wall pipe chase tube wall construction and finally flows back into the apparatus of claim 1, rear drain/(s) section of the over flow box filter, this completes the over flow cycle for the apparatus of claim 3, manual prime overflow box filter enclosure version;
by replacing apparatus of claim 1, manual prime version of the over flow box filter with the said apparatus of claim 1, optional alternate electronic prime overflow box filter enclosure conversion controller kit version, the said apparatus of claim 1, optional alternate electronic prime overflow box filter enclosure conversion controller kit version can be prepped with the transfer a small portion of water into the apparatus of claim 1, rear drain section of the over flow box filter which is located in the apparatus of claim 1, rear drain/(s) section, of the over flow box filter which straddles the opposite, or outside face, of any tank rim, edge or lip, in the same way as the apparatus of claim 3, manual prime overflow box filter enclosure version;
once prepped, the apparatus of claim 1, over-the-wall pipe chase tube wall construction can be primed via the siphoning action which is provided by the apparatus of claim 3, alternate electronic prime conversion controller kit version on/off switch, where here, the said apparatus of claim 1, over-the-wall pipe chase construction that was connected to the apparatus of claim 3, external airline tube, which in turn was connected to the apparatus of claim 3, control valve, has been replaced;
said apparatus of claim 3, automatic siphon controller with power on/off switch, is now plumbed into the top of the said apparatus of claim 1, over-the-wall pipe chase construction, and the apparatus of claim 3, prime bulb with bubble check, has been added so that it is readily accessible from outside of the over flow box filter;
wherein the apparatus of claim 3, the automatic siphon controller power on/off switch is pressed or engaged, this causing all the air contained in the said apparatus of claim 1, over-the-wall pipe chase construction to be drawn out;
once said air contained in the apparatus of claim 1, over-the-wall pipe chase construction, is removed completely, and water appears in the apparatus of claim 3, external prime bulb with bubble check, which in turn is plumbed into the apparatus of claim 1, over-the-wall pipe chase construction, then discontinue engagement of the apparatus of claim 3, automatic siphon controller power on/off switch, and depress the apparatus of claim 3, external prime bulb with bubble check several times to seal off the apparatus of claim 1, over-the-wall pipe chase construction;
with the apparatus of claim 1, alternate electronic prime conversion controller kit version now primed, sealed, and closed, should the water supply or the external supply power to the external pump shut off for any reason, the apparatus of claim 1, raised drain lip/(s) located in the apparatus of claim 1, rear drain/(s) section of the over flow box filter, and the apparatus of claim 1, raised surface skim slots located on the main tank/habitat chamber containment area side of the over flow box filter, will keep the apparatus of claim 1, over-the-wall pipe chase construction inflow and outflow slot/(s) fully submerged;
said self-leveling or equalization effect between both the apparatus of claim 1, front supply side of the over flow box filter and the apparatus of claim 1, back drain side of the over flow box filter will discontinue any flow and sit fully primed while stationed at an idle, until power to the external filter pump is restored and supply to the apparatus of claim 1, over flow box filter external connection supply inflow port is returned;
once powered up again, the apparatus of claim 1, alternate electronic prime conversion controller kit version begins with its gravity water feed from the apparatus of claim 1, sequence of top surface skimming slots;
said water then travels up and over the apparatus of claim 1, over-the-wall pipe chase construction and finally flows back into the apparatus of claim 1, rear drain/(s) section, this completes the over flow box filter cycle for the apparatus of claim 3, alternate electronic prime conversion controller kit version.

4. The apparatus of claim 1, wherein the layout comprises a manual top-off water fill, additive, and feeding port which resides above the apparatus of claim 4, internal cyclonic transfer chamber which leads down to the apparatus of claim 4, submerged top-off water fill, additive, and food release port;
said apparatus of claim 1, manual top-off water fill, additive, and feeding port being used for manually adding top-off water to the main tank/habitat chamber containment area after evaporation has taken place and/or the addition of manually introduced water treatments, additives or food into the main tank/habitat chamber containment area for submerged release or feeding;
said apparatus of claim 1, manual water fill and feeding port also provides a location to mount the apparatus of claim 4, clip-on manual feeder assembly, in addition to the apparatus of claim 4, alternate clip-on electronic feeder assembly version;
said versions both being readily attachable to the apparatus of claim 1, manual water fill and feeding port combination for the ease of manually or automatically adding food into the main tank/habitat chamber containment area via the apparatus of claim 4, internal cyclonic transfer chamber which is actively fed by the apparatus of claim 4, submerged internal supply pipe, and which leads directly down to the apparatus of claim 4, submerged top-off water fill, additive, and food release port which is located submerged underwater on the apparatus of claim 1, front supply side of the over flow box filter;

5. The apparatus of claim 1, wherein the layout comprises both the apparatus of claim 4, clip-on manual feeder assembly, in addition to the apparatus of claim 4, alternate clip-on electronic feeder assembly version which can be mounted separately and on their own to the apparatus of claim 5, sliding soak feeder tank wall clip, while performing their same feeding functionalities separately from the apparatus of claim 1, over flow box filter.

6. The apparatus of claim 1, wherein the layout comprises a mounting port which can house the apparatus of claim 6, an assortment of bi-directional and adjustable flow manifolds as well as other aftermarket powerhead assemblies which can assist with the main tank/habitat chamber containment area circulation and water return inflow.

7. The apparatus of claim 1, wherein the layout comprises both the apparatus of claim 1, back internal drain/(s) of the over flow box filter and the apparatus of claim 7, dual drain to one single drain pipe conversion adapter, which can be used to plumb two independent drains to one single drain when needed.

8. The apparatus of claim 1, wherein the layout comprises the apparatus of claim 8, a controller interface which works in conjunction with the apparatus of claim 8, sensors and the apparatus of claim 8, probes to provide the apparatus of claim 8, digital display readout for the various water conditions which are present in the overall main tank/habitat chamber containment area.

9. The apparatus of claim 1, wherein the layout comprises the apparatus of claim 9, integration of the apparatus of claim 1, over flow box filter, into a compatible and like designed complete system for the internal and external transfer, purification, and processing which is used in maintaining water quality in aquatic environments.
